(19) United States
(12) Patent Application Publication
(10) Pub. No.: US 2020/0387533 A1
(43) Pub. Date: Dec. 10, 2020

(54) SYSTEMS AND METHODS FOR STRUCTURING METADATA

(71) Applicant: Zetadata Systems, Inc, Northridge, CA (US)

(72) Inventors: Wanja Nolte, Munich (DE); Thomas Huber, Berg (DE); Petra Schemmel, Gauting (DE); Mica Imamura, Tokyo (JP); Jackie Mountain, Northridge, CA (US); Thomas Witt, Munich (DE); Denise Pache, Weil (DE); Stephen Bleek, Worthsee-Steinebach (DE); Marian Schuba, Bochum (DE)

(21) Appl. No.: 16/820,885

(22) Filed: Mar. 17, 2020

Related U.S. Application Data
(60) Provisional application No. 62/820,772, filed on Mar. 19, 2019.

(51) Int. Cl. G06F 16/45; G06K 9/00; G06F 40/279; G06F 40/247; G06F 16/48; G06F 16/41; G06F 16/22; G06N 20/00

(52) U.S. Cl. CPC G06F 16/45; G06K 9/00718; G06F 40/279; G06N 20/00; G06F 16/48; G06F 16/41; G06F 16/2246; G06F 40/247

(57) ABSTRACT

Systems and methods for structuring metadata associated with digital media content such as images and videos are disclosed. Use of an existing hierarchical taxonomy provides a set of structured metadata to organize unstructured data stored in an electronic media archive. As digital media content is submitted to the archive, metadata keywords are user-selected from the existing taxonomy to identify and describe the digital media content, and to position the content within the hierarchical structure. The selected metadata keywords can then be automatically associated with synonyms and related terms to build an ontological network that facilitates efficient retrieval of the content when searching the electronic media archive. Each node in the taxonomy is then linked to its foreign language counterparts, allowing the content to be located in an international search. Metadata structured using such a hierarchical taxonomy can be provided as a multi-dimensional dataset for artificial intelligence applications and machine learning.

### TECHNICAL FIELD

The present disclosure relates to the creation, organization, classification, and management of metadata associated with digital media content stored in an electronic archive and, in particular, methods and systems that facilitate efficient storage and retrieval of digital images and videos to and from an electronic archive.

### BACKGROUND

### Description of the Related Art

The volume of digital media being produced and uploaded to the Internet is rising exponentially. Most of this data, including image and video data, is stored in an unstructured, disorganized manner. Well-known services that archive digital images and videos include, for example, search engines, e.g., YouTube™; stock image providers, e.g., Getty Images™, Shutterstock™; social media sites, e.g., Pinterest™, Instagram™ various libraries, advertising and marketing agencies, and the like. Individual digital images, or sequences of images (videos) are typically archived with only a minimal amount of descriptive metadata to facilitate their organization and retrieval from an electronic database. Image classification and storage management pose challenges to such services, and will likely continue to be an area of focus in the future.

When an image or video is uploaded by a user to a conventional digital media service, the user may be queried for a few items of descriptive metadata. A typical metadata query may consist of a fillable form having a few data fields, for example, a keyword field, a name field, and a title field. The uploading software may also attach a date/timestamp and/or a geographical positioning system (GPS) location indicating the time and place where the data was received and stored in the archive.

A conventional digital archive allows a user to upload media content accompanied by keywords that can be used to identify and categorize the content for later retrieval. In existing systems, the user submits keywords using open field text labeling. That is, descriptive words and phrases are chosen arbitrarily by the user, and an open data field accepts whatever random tags the user enters. Because such a free-form entry scheme does not filter or control keywords, they may contain spelling or factual errors that thwart subsequent efforts to search for and retrieve the media content. In some instances the user may choose inaccurate keywords, or too few keywords. When misspelled or incorrect keywords are entered, even though the media content may be successfully stored in the database, the content may be effectively lost, simply because it is unlikely to be located by keyword searching.

Synonymous keywords are generally not associated with one another in the archive, further contributing to poor searchability of the content. Consequently, if a searcher fails to select the exact keywords stored as metadata, the content may not be retrieved. An effective search therefore may require many rounds of trial and error, thereby reducing productivity. Furthermore, mis-filings and failure to associate similar keywords may result in lost revenue for those who own rights to the media content.

Existing digital archives generally do not support foreign language metadata to allow for subsequent worldwide searching. As a result, searching for an English keyword would fail to locate media content stored under a corresponding word in any other language, thus restricting an intended global search to only a few countries, or even to a single country. Failure to retrieve content because of language incompatibility may result in another lost revenue opportunity for the owner.

Accordingly, it is desirable to overcome such shortcomings of conventional systems, and to overcome limitations brought about by the unstructured archiving of digital media content.

### BRIEF SUMMARY

Systems and methods are provided that use structured metadata to organize and classify digital media such as images and videos in an electronic archive suitable for long-term data management. A digital image classification system as disclosed herein features a controlled keyword vocabulary that restricts a user's choice of descriptors to a pre-determined set of keywords arranged as nodes in a network. Such a controlled system eliminates spelling errors, reduces ambiguity, creates consistency, and improves accessibility of content for subsequent retrieval.

In accordance with the inventive systems and methods, digital media content may be submitted, or logged, into the digital image classification system using a menu-driven process in which keyword metadata is user-selected from an existing taxonomy. The digital media content may be logged during creation, during editing, or during post-production and delivery. The keyword metadata is used to classify the content within an existing hierarchical structure. The selected keywords are then automatically associated with synonyms and related terms to build an ontological network that facilitates efficient retrieval of the content when searching the electronic media archive. Thus, as soon as media content is submitted, it is linked to an existing multi-dimensional network in which keywords are already interconnected within the structured data archive. Each node in the network is further linked to its foreign language counterparts, allowing content to be located in an international search. Digital media content classification as described herein may also be used to retrofit existing content by mapping original metadata from archival media to new metadata fields. Other metadata elements associated with a digital image or video include, in addition to keywords, objective technical characteristics of the image or video such as the shot angle, the type of camera used, the number of frames in the video, and the like, as well as rights information relating to the copyright, or the talent, logos, or other protected items within the image or video.

As each node is added to the network, a transaction occurs, resulting in a sequence of transactions that may be managed using block chain techniques. The use of block chain technology to manage a structured media archive as described herein may be similar to the way in which block chain technology is used for supply chain management in a manufacturing enterprise.

In some implementations, digital media content may be automatically logged into the image classification system by machines instead of by human users. Smart machines may automatically select metadata elements from information contained in the digital media content. For example, a smart machine may be programmed to automatically extract keywords from text. In another example, a machine having computer vision capability may analyze a digital image or video and, through image recognition, may identify some aspect of the image, e.g., the subject of the image(s), or other identifying characteristics, such as features of the subject, location, activity depicted within the image frame, and the like. The machine may then automatically select an initial keyword from the taxonomy to describe the identified subject or feature(s). The initial keyword may then automatically associate parent keywords, child keywords, and/or related terms within the hierarchical classification system with the digital image(s). Using a hierarchical taxonomy in this way can increase the performance of machine learning and computer vision models, by extrapolating, from machine generated inputs into the taxonomy, more general concepts at higher levels of the network. Subsequent connection of the initial keyword with related descriptors via the built-in ontological network may provide feedback to the computer vision device to improve accuracy of its automatic image identification functionality.

In some implementations of the digital media content classification system, a search engine, e.g., Google™, Yahoo™, Bing™, YouTube™, or the like, may be coupled to the ontological network. The classification system may be programmed to dynamically score keywords according to their relative value in the context of search engine optimization (SEO). A SEO score can then be used to provide guidance to a user or a machine in selecting the best keywords for either classifying digital media content, or for use in searching for digital media content. Accordingly, metadata that is structured using the hierarchical taxonomy described herein can be provided as a multi-dimensional dataset for artificial intelligence applications and machine learning.

Effective organization using the techniques described herein to produce structured metadata converts unstructured digital media content into a media asset in the form of a product that can be retrieved easily for internal uses by the media asset owner, or for licensing or sale to external customers. Customers can be media production related, desiring to license or purchase digital media products, e.g., images or video assets, may include, for example, film studios, entertainment production companies, electronic newspapers and magazines, educational institutions, advertisers, marketing companies, travel-related businesses, medical imaging businesses, any other companies having substantial digital or digitizable video or image assets, or any business that generates its own marketing, sales, educational, and promotional materials. Customers can also be from the scientific, academic, research, or engineering community, seeking to use images and video along with rich, accurate metadata for various use cases.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been selected solely for ease of recognition in the drawings.

FIG. 1 is a block diagram of a digital media content classification system, according to the invention as described herein.

FIG. 2 is a block diagram showing relationships between video content and metadata elements for use in classifying the video content, according to the invention as described herein.

FIG. 3 shows the general structure of a hierarchical taxonomy, according to the invention as described herein.

FIG. 4 is a network diagram of a portion of an exemplary hierarchical taxonomy according to the invention as described herein.

FIG. 5 shows an exemplary digital image, onto which are superimposed three keywording trees describing the subject, geography, and environment of the image, according to the invention as described herein.

FIG. 6 shows the exemplary digital image of FIG. 5, onto which is superimposed a fourth keywording tree describing actions in the image, according to the invention as described herein.

FIG. 7 is a network diagram illustrating object keywording, according to the invention as described herein.

FIGS. 8-11 are screen shots of a menu-driven user interface for logging and managing digital media content and metadata, according to the invention as described herein.

FIGS. 12A-12B are screen shots of a video player and a shot window, respectively, according to the invention as described herein.

FIGS. 13A-13C are screen shots of a user interface for managing an archive containing videos, according to the invention as described herein.

FIG. 14A is a screen shot of a user interface for viewing individual frames of a video clip, according to the invention as described herein.

FIG. 14B is a screen shot of a user interface for viewing a catalogue of videos, according to the invention as described herein

FIGS. 15A-15B and 16A-16C are screen shots of a user interface for managing keyword metadata describing video content, according to the invention as described herein.

FIG. 17 is a screen shot showing synonym mapping and multi-lingual mapping to keywords, according to the invention as described herein.

FIG. 18 is a screen shot of representing a bin containing a group of related videos, according to the invention as described herein.

FIGS. 19A-19D and 20A-20B are screen shots of a user interface for managing bins of related videos, according to the invention as described herein.

FIG. 21 is a flow diagram showing a method of automating the editing process for a documentary film using a keyword taxonomy augmented with artificial intelligence technology, according to the invention as described herein.

FIG. 22 is a chart showing a first example of existing external information that may be combined with metadata as described herein to enhance machine learning results.

FIG. 23 is a chart showing a second example of existing external information that may be combined with metadata as described herein to enhance machine learning results.

FIG. 24A is a flow diagram of a training phase for machine learning, according to the invention as described herein.

FIG. 24B is a flow diagram of a prediction phase for machine learning, according to the invention as described herein.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Unless the context requires otherwise, throughout the specification and claims that follow, the word “comprising” is synonymous with “including,” and is inclusive or open-ended (i.e., does not exclude additional, un-recited elements or method acts).

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not limit the scope or meaning of the embodiments.

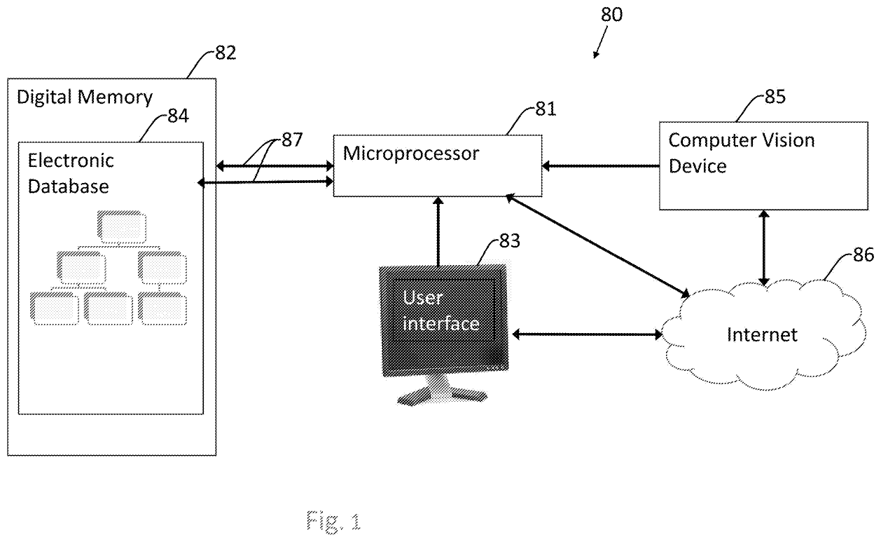

FIG. 1 shows a digital media content classification system 80, according to an embodiment of the present disclosure. The digital media content classification system 80 is suitable for long-term management of digital media content and associated metadata. The digital media content classification system 80 includes a microprocessor 81, a digital memory 82, a user interface 83, an electronic database 84, and optionally, a computer vision device 85. The digital media content classification system 80 may also include one or more communication paths coupling components of the digital media content classification system 80 to the Internet 86. The electronic database 84 may be implemented within the digital memory 82 using a conventional relational database architecture. The microprocessor 81 of the digital media content classification system 80 is programmed to manage a data archive stored in the electronic database 84 as described herein. The microprocessor 81 is coupled to the digital memory 82 and the user interface 83 via a bi-directional communication bus 87.

The user interface 83 allows a human being to transmit and retrieve data to and from the data archive, via the microprocessor 81. In particular, the user interface 83 is a data input device that accepts from the user new digital media content, metadata inputs for use in content classification, and search requests to access archived digital media content. The user interface 83 may be, for example, a touch screen display, a monitor and/or keyboard, a keypad, a microphone, a mobile device such as a smart phone, or any other device suitable for capturing and transmitting user input to the microprocessor 81. The user interface 83 may be programmed to query from a user various types of metadata pertaining to digital media content being submitted to the archive, or already stored in the archive. Such metadata describing the digital media content may include for example, numeric metadata, predefined attributes of digital media content, and keyword metadata.

In addition to, or as an alternative to the user interface 83, the digital media content classification system 80 may use the computer vision device 85 as an automated data input device. The computer vision device 85 is a smart machine capable of interpreting digital images within the digital media content. The computer vision device 85 may be programmed with, for example, image recognition or pattern recognition algorithms. Such algorithms may permit the computer vision device 85 to detect representations of objects, people, activities, animals, plants, landmarks, buildings, and the like, contained in digital media content to be archived. The computer vision device may also be programmed to detect scene breaks, spoken words, and other elements in a video or video clip. The computer vision device 85 may be further programmed to automatically submit items of digital media content and to generate and submit to the archive keyword metadata describing the digital media content. The computer vision device 85 may also identify such representations among digital media content already archived in the electronic database 84. The computer vision device 85 may employ machine learning or artificial intelligence techniques. Such techniques may cause the computer vision device 85 to become more efficient at detecting the subject matter of digital images, over time and with experience.

Those of ordinary skill in the art will appreciate that one or more circuits and/or software may be used to implement the systems and methods for structuring metadata as described herein. Circuits refer to any circuit, whether integrated or external to a processing unit such as a hardware processor. Software refers to code or instructions executable by a computing device using any hardware component such as a processor to achieve the desired result. This software may be stored locally or stored remotely and accessed over a communication network.

In the systems and methods for structuring metadata as described herein, digital memory may be used to store data in a variety of configurations. As is known by one skilled in the art, such digital memory may include any combination of volatile and non-volatile, transitory and non-transitory computer-readable media for reading and writing. Volatile computer-readable media includes, for example, random access memory (RAM). Non-volatile computer-readable media includes, for example, read only memory (ROM), magnetic media such as a hard-disk, an optical disk drive, a flash memory device, a CD-ROM, and/or the like. In some cases, a particular digital memory is separated virtually or physically into separate areas, such as a first memory, a second memory, a third memory, and the like. In these cases, it is understood that the different divisions of memory may be in different devices or embodied in a single memory.

Additionally or alternatively, the memory may be a non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Additionally or alternatively, each file may include data or other computational support material useful to carry out the computing functions of the systems, methods, and apparatus described in the present disclosure.

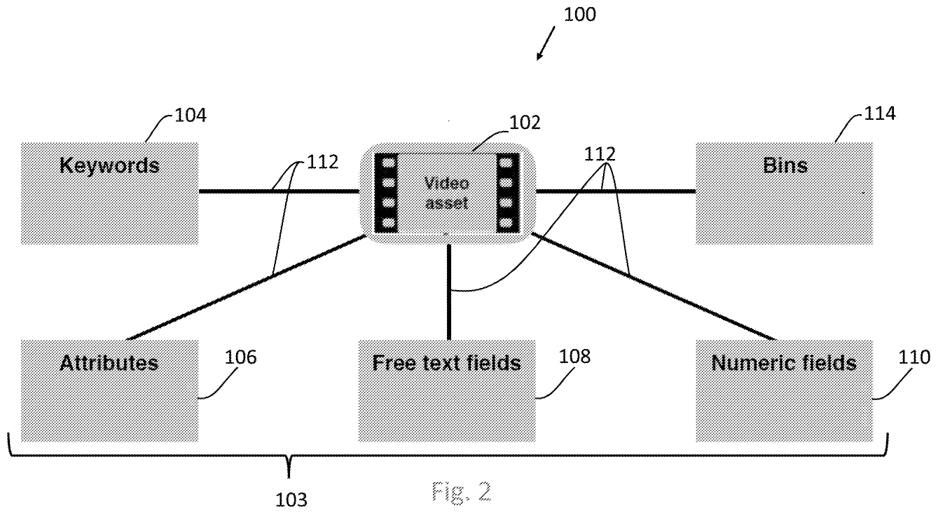

FIG. 2 shows an exemplary data family 100 stored within the electronic database 84, according to an embodiment of the present disclosure. The data family 100 is structured so as to efficiently store and retrieve digital media content to and from the electronic database 84. The data family 100 includes at least an item of digital media content and associated metadata. The digital media content is typically accepted as input into the electronic database 84 at the time when it is created. For example, a video is recorded at a geographic location and soon thereafter, the video is uploaded for archiving in the electronic database 84.

In FIG. 2 and in subsequent illustrative examples described herein, the digital media content is in the form of a video asset 102. However, the digital media content is not limited to video content. Other forms of digital media content may include digital images, digital audio tracks, or digital print media containing digital text information such as articles, books, reference data, indices, and the like. The term digital, as used herein, generally includes information that was originally recorded in a non-digital form and was later digitized.

The video asset 102 is a sequence of digital video images, or frames. The video asset 102 may be an entire video (“production”), a multi-shot video clip, a single-shot video clip, or combinations thereof. Most video clips are short individual shots, having an average shot length of 17 seconds. Accordingly, the terms “video,” “video clip” and “shot” are used interchangeably herein. The size of each frame is arbitrary, as is the number of frames in the sequence. One image frame of the video asset 102 may be designated as a representative master key frame. The digital video images of video asset 102 may be digitized versions of images that were originally captured on photographic film, e.g., as still images or as a movie on a film strip. The exemplary video asset 102 represents any one of a range of frame sequence types and lengths, e.g., from a short video clip used for advertising, to a full feature movie. Each video asset 102 has associated ownership rights. The video asset 102 may have been professionally produced and edited, and may have significant monetary value.

The digital media content classification system 80 classifies the video asset 102 using associated metadata 103 shown in FIG. 2 such as, for example, keywords 104, attributes 106, free text fields 108, and numeric fields 110. Metadata 103 includes any data residing in the electronic database 84 that relates to the video asset 102. Each element of metadata 103 is stored in the electronic database 84 and is communicationally coupled to the video asset 102 by a link 112. Links 112 provide communication paths by which the video asset may be retrieved from the electronic database 84. Links 112 may be established by data mapping within the archive. Within the electronic database 84, video assets 102 may be sorted into bins 114 containing groups of similar video clips, or image collections, or groups of video clips that were recorded at a similar time. The bins 114 may also contain bin identification information or historic information such as recording dates.

A keyword 104 may describe a particular aspect or characteristic of one or more images of the video asset 102. For example, keywords may describe a subject in the image(s), e.g., a human, an animal, a plant, or a building, a geographic location, an environment surrounding the subject, a landscape feature, actions depicted in a scene of the image, and the like. In the digital media content classification system 80, keywords 104 are prescribed descriptors in that they are restricted to terms that are part of an existing taxonomy, as described below. When new keywords 104 are added, they are interconnected with other keywords so as to become part of the existing taxonomy.

Attributes 106 may include various technical descriptors of the video asset 102, for example, the date, time, and location where the video was recorded, information associated with photographic equipment used to capture the video images such as camera settings, shot identification information, shot details, shot categories, audio equipment information, and the like. Other attributes 106 may include rights information associated with the video asset 102 such as, for example, copyright information, talent rights information, organizer rights information, brand name information, logo information, and the like. Attributes 106 may be recorded in the digital content classification system by a user or they may be recorded automatically by a machine, e.g., from data that is stored with the digital content. Attributes 106 are prescribed descriptors, that is, they are determined prior to a user accessing the video asset 102 via the electronic database 84. Although a user may record the information of attributes 106 in the archive, the user is not involved in generating or creating the information of attributes 106.

Free text fields 108 include user-defined text such as, for example, titles or captions relating to the whole video asset 102, to individual frames of the video asset 102, or to a master key frame of the video asset 102.

A numeric field 110 is a prescribed descriptor that identifies a single video asset 102 without ambiguity, e.g., an ID number.

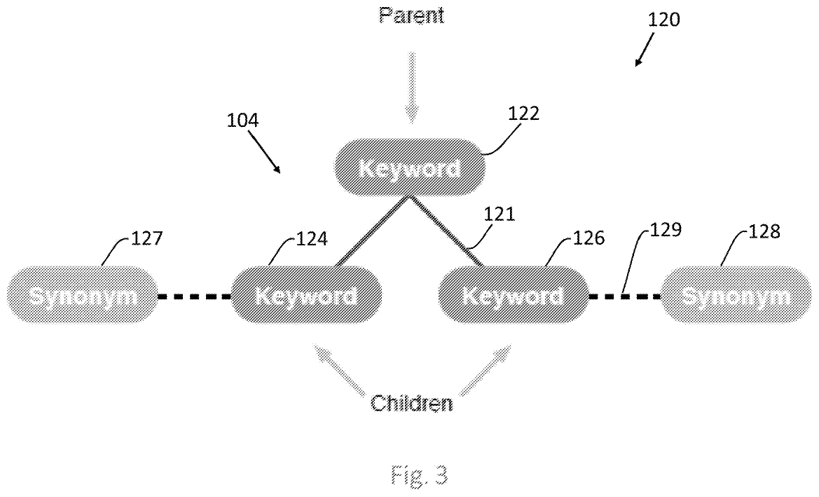

FIG. 3 shows a generic hierarchical classification structure 120, according to an embodiment of the present disclosure. The hierarchical classification structure 120 is used by the digital media content classification system 80 to organize the keyword metadata 104. The hierarchical classification structure 120 includes keywords 104 arranged as primary nodes in a network (three examples shown: 122, 124, 126). The network facilitates efficient retrieval of the video asset 102 from the electronic database 84. The primary nodes 122, 124, and 126 are communicationally coupled to one another by links 121. In some implementations, the hierarchical classification structure 120 is a data tree in which the principal nodes of the network bear keywords 104 describing a selected aspect of the digital content. In the hierarchical classification structure 120, the principal nodes 104 are arranged in top-down order such that a parent node 122 bearing a general keyword 104, is displayed at a higher level of the data tree, and child nodes 126 bearing keywords 104 that describe a specific category of the digital content, are displayed at lower levels of the data tree, relative to the parent node 122. That is, the keywords 104 are placed higher or lower in the data tree according to their specificity. Accordingly, family relationships can be thought of as a first, vertical dimension of the hierarchical classification structure 120.

Structured metadata 103 used by the digital media content classification system 80 and arranged in the hierarchical classification structure 120, is generated according to methods as described herein, such that keywords 104 are part of an existing taxonomy, and parent/child relationships of the keywords 104 are pre-established. The digital media content classification system 80 utilizes a controlled keyword vocabulary scheme in which the hierarchical classification structure 120, once formed, is fixed. Thus, when a new keyword 104 is selected to describe the video asset 102, an existing network linking the keyword 104 to its family members is already built-in, and therefore the video asset 102 is instantly accessible and can be retrieved very quickly through the interconnected network, via the links 121.

Synonyms 128 of the keywords 104 may be provided as additional nodes in the interconnected network of the hierarchical classification structure 120. A synonym 127 has a similar meaning to that of its associated keyword 124 and therefore has a similar specificity to that of the associated keyword 124. Likewise, a synonym 128 has a similar meaning to that of its associated keyword 126 and therefore has a similar specificity to that of the associated keyword 126. Accordingly, synonyms 127, 128 are displayed at a same level of the hierarchical classification structure 120 as their associated keywords 124, 126, respectively. Synonyms 127, 128 are coupled to their associated keywords 124, 126 by links 129. Synonyms 127, 128 can be thought of as a second, horizontal dimension of the hierarchical classification structure 120. When a keyword 104 is selected by a user to describe a video asset 102, the existing network linking the keyword 104 to its synonyms is already built-in, and therefore the video asset 102 is instantly accessible through the network via the links 129.

In similar fashion, related terms whose meanings are not necessarily synonymous with the keyword 104, but are nevertheless associated with the keyword 104, may also be provided as additional nodes in the interconnected network of the hierarchical classification structure 120. Such terms may be related to the keyword 104 according to their meaning, common usage, or other characteristic. There is no hierarchical relationship between the keyword 104 and a related term. When a keyword 104 is submitted by a user to describe a video asset 102, the existing network linking the keyword 104 to its related terms is already built-in, and therefore is instantly accessible. Related terms can therefore be thought of as a third dimension of the hierarchical classification structure 120.

In similar fashion, foreign translations of the keyword 104 may also be provided as additional nodes in the interconnected network the hierarchical classification structure 120. When a keyword 104 is submitted by a user to describe a video asset 102, the existing network linking the keyword 104 to its foreign translations is already built-in, and therefore the video asset 102 is instantly accessible. This feature permits a user to perform a search for digital media assets stored in the electronic database 84 in any of the foreign languages that are supported, by entering a keyword search in only one language. Such a capability can increase productivity substantially. More importantly, foreign translation capability can improve the chance that the digital media assets can be found worldwide, which can significantly affect the value of the asset. For example, a video that is able to be located from anywhere the world by typing in keywords in any one of the most commonly used languages, may be leased or purchased many more times than a video that can only be located by entering keywords in one particular language, thus providing more revenue to whomever owns the rights to the video. Foreign translations can be thought of as a fourth dimension of the hierarchical classification structure 120.

The systems and methods described herein that provide structured metadata for digital media content and, in particular, for video and still images, may be suitable for use in tagging content on Internet sharing sites such as YouTube™, Vimeo™, Facebook™, Instagram™, and the like.

FIG. 4 shows a keywording tree 130, according to an embodiment of the present disclosure. The keywording tree 130 is a data tree arranged according to the general hierarchical classification structure 120 of FIG. 3. The keywording tree 130 is made up of principal nodes bearing geographical keywords that describe image locations. Each keywording tree 130 is arranged in order of specificity such that keywords at the top of the hierarchical classification structure 120 are the most general, and the keywords at the bottom of the hierarchical classification structure 120 are the most specific. For example, at the top of the keywording tree 130, a parent node 142 bears the generic keyword “Geography.” The parent node 142 is linked to a first branch 140 under the child node 146, “Europe,” and a second branch 150 under the child node 152, “America.” The child node 152 is then linked to a grandchild node 154, “North America,” and so on, down to the bottom node 160, “Los Angeles”, which specifies a particular city in North America. Likewise, the child node 146, “Europe,” is linked to a grandchild node 156, “Mid-Europe,” and so on, down to a bottom node 162, “Munich”, which specifies a particular city in Mid-Europe.

A complete taxonomy of keywords in an existing image classification system that has been generated according to the present disclosure includes approximately 85,000 English language keywords; a thesaurus of 30,000 synonyms; 12,000 related terms, and multi-lingual mapping that provides translations of each keyword into each of six foreign languages. Accordingly, the ontological network of this particular image classification system currently encompasses about 890,000 nodes, and will soon grow to encompass one million nodes.

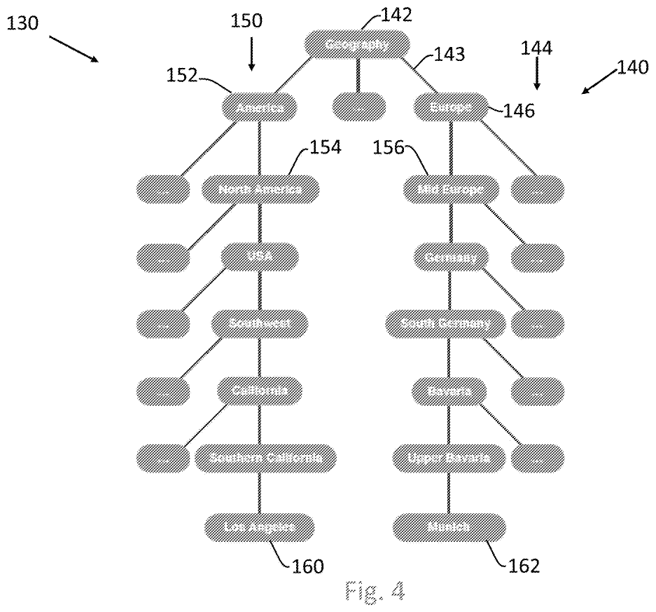

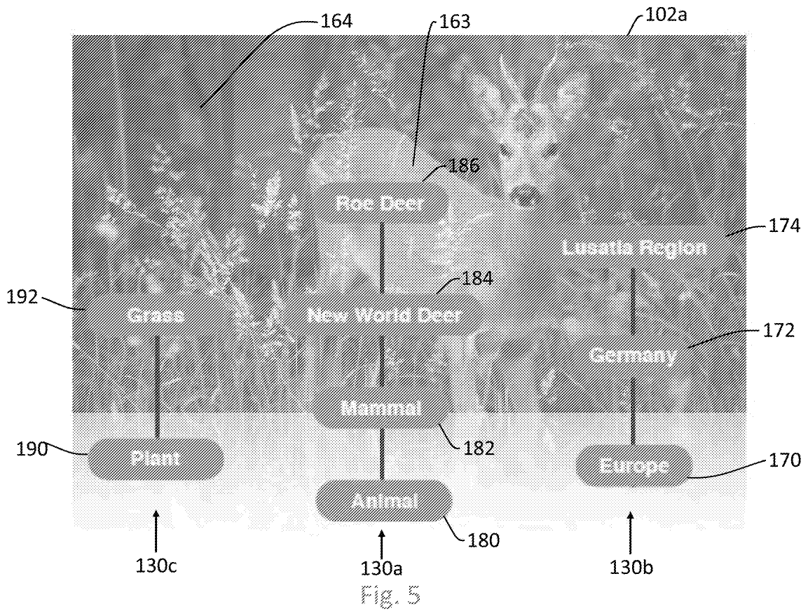

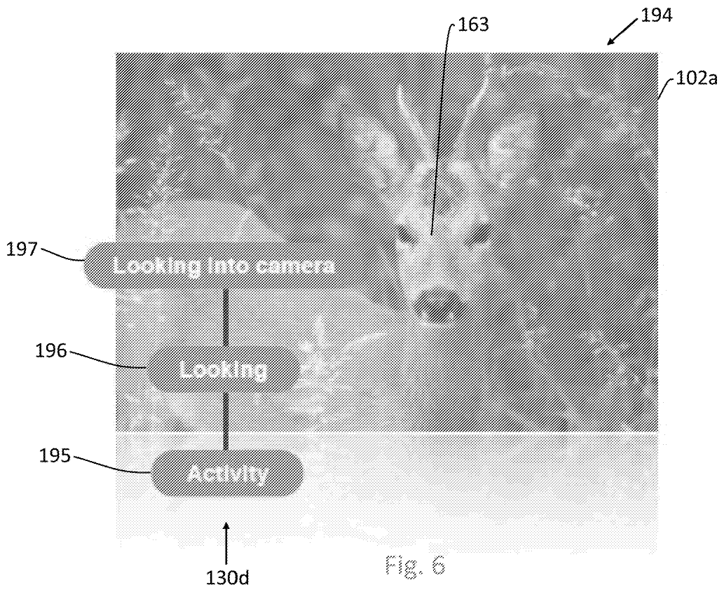

FIGS. 5-6 show the relationship between an exemplary single frame 102a of the video asset 102 and the structured metadata as described above, according to an embodiment of the present disclosure. The frame 102a bears an image of a deer 163 standing in a meadow environment 164. The frame 102a may be a master key frame representing the exemplary video asset 102. Superimposed on the image of the deer 163 as shown in FIG. 5 are three exemplary keywording trees 130a, 130b, and 130c, each keywording tree including principal nodes bearing keywords that describe a particular aspect of the frame 102a. A first, central keywording tree 130a includes nodes 180-186 bearing keywords that describe the subject, that is, the deer 163, arranged in a hierarchical structure as described above. The node 180 bears the most general subject keyword in the keywording tree 130a, or parent, “Animal”, which is linked to a child keyword “Mammal” at node 182, which is in turn linked to a grandchild keyword “New World Deer” at node 184, which is finally linked to the most specific, great grandchild keyword in the keywording tree 130a, “Roe Deer” at node 186.

A second keywording tree 130b includes additional principal nodes 170-174 bearing keywords that describe the geographic location where the frame 102a was recorded. The node 170 bears the most general geographic location keyword in the keywording tree 130b, or parent, “Europe” which is linked to child keyword “Germany” at node 172, which is linked to the most specific, grandchild keyword “Lusatia Region” at node 174.

A third exemplary keywording tree 130c includes additional principal nodes 190-192 bearing keywords that describe the environment depicted in the frame 102a. The node 190 bears the most general environmental keyword in the keywording tree 130c, or parent, “Plant” which is linked to a specific child keyword “Grass” at node 192.

FIG. 6 shows a magnified view 194 of the deer 163, onto which is superimposed a fourth exemplary keywording tree 130d. The keywording tree 130d includes principal nodes 195-197 bearing keywords that describe actions depicted in the image. The node 195 bears the most general keyword “Activity” which is linked to a child keyword “Looking” at node 196, which is in turn linked to the most specific grandchild keyword in the keywording tree 130d, “Looking into camera” at node 197. Each of the principal nodes of the keywording trees 130a, 130b, 130c, and 130d may also be linked to synonyms, related terms, and foreign language translations, as described above.

FIG. 7 shows an object ontology 198, in which keywords may be associated with individual objects of a video asset 102. Continuing with the example of the video of the deer in the meadow shown in FIGS. 5-6, the video asset 102 as a whole includes objects 163 (deer) and 164 (meadow environment). Using asset-based keywording, the general keywords “Animal,” 180 “Plant,” 190 and “Germany” 172 are attached to the video asset 102. Using object-based keywording, the specific keywords “Roe Deer” 186 and “Looking” 196 are attached to object 163, and the specific keywords “Grass” 192 and “Lusatia Region” 174 are attached to the object 164, instead of, or in addition to being attached to the video asset 102 as a whole. Additional localization information may also be attached to objects. The object ontology 198 may be applied to each individual video asset 102 or to a whole keywording project to enhance metadata accuracy and to facilitate the use of AI video annotation.

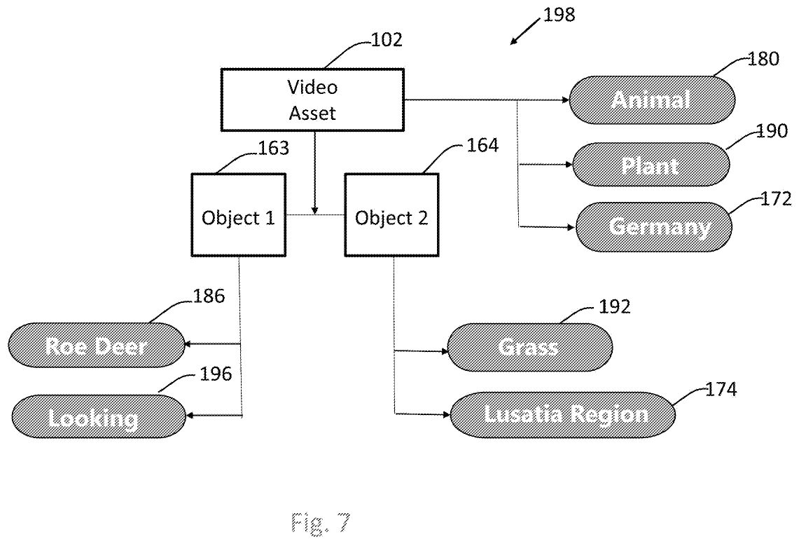

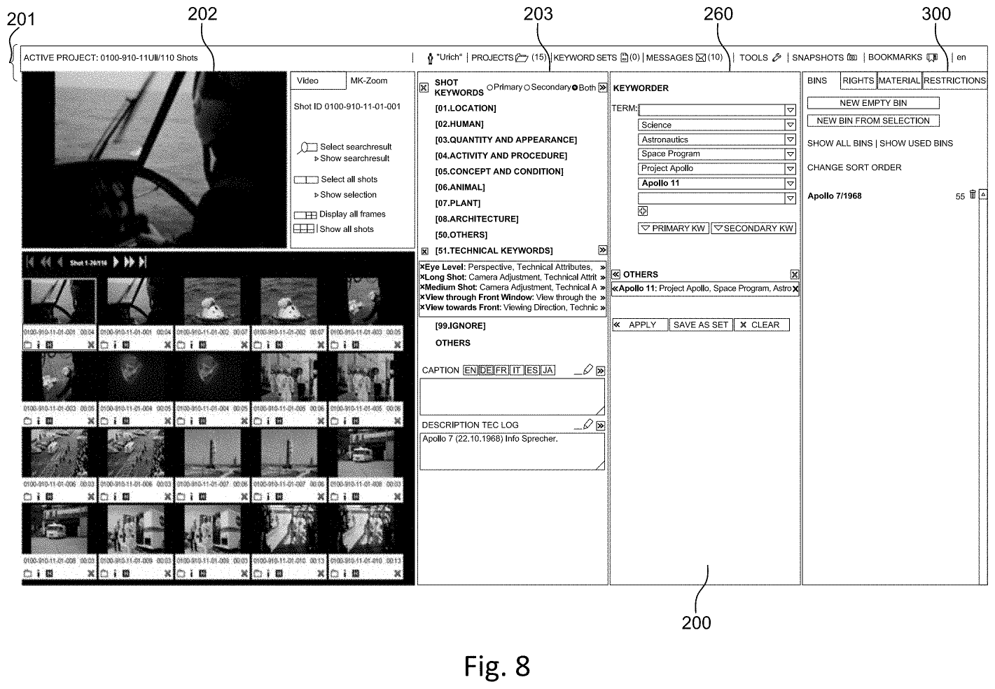

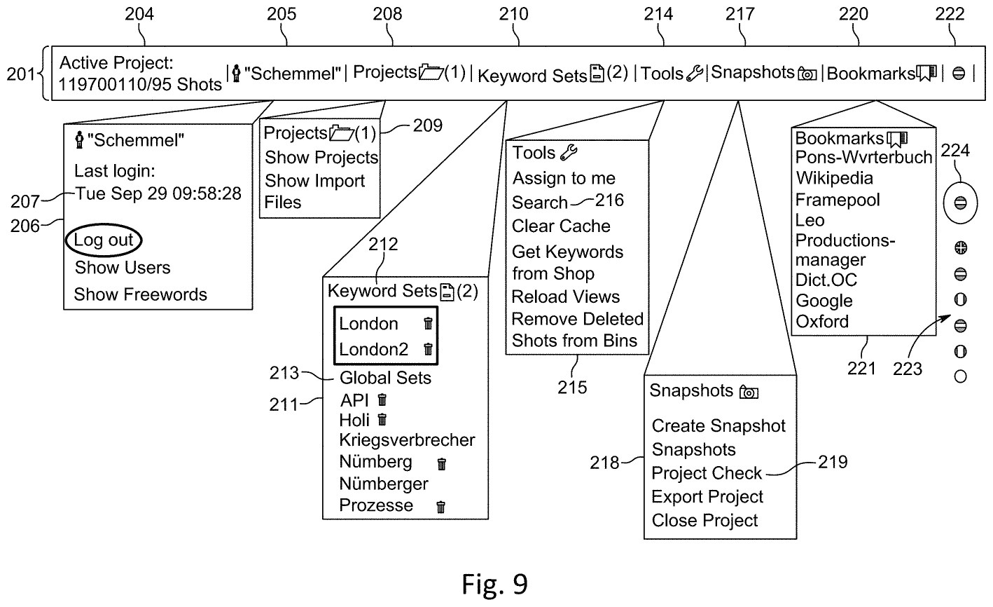

FIGS. 8-11, 12A-12B, 13A-13C, 14A-14B, 15A-15B, 16A-16C, 17, 18, 19A-19D, and 20A-20B show screen shots of a manual logger 200, according to an embodiment of the present disclosure. The logger 200 is a menu-driven user interface tool for archiving new digital media content and associated metadata into the electronic database 84, and for managing the archive. The logger 200 is suitable for use with the user interface 83 to the digital content classification system 80. The logger 200 may be executed by the microprocessor 81. In the exemplary implementation shown in FIGS. 8-9, the logger 200 is configured for use in logging video content, e.g., the video asset 102. However, the logger 200 may be configured differently for use in managing other types of digital media content in addition to, or instead of, video content. The manual logger 200 shows by example the structure of an actual digital media archive having the features described above. In some implementations, certain functions of the logger 200 may be automated so that they are handled automatically without a need for user input. In such cases, the manual logger 200 will continue be used, for example, to view and manage archived content, to view and manage bins, and other functions of video production. The logger 200 may be used in conjunction with existing video editing suites such as, for example, FinalCutPro™, Adobe Premier™, and Avid Media Composer™.

FIG. 8 shows the home screen of the logger 200 for display on the user interface 83. The logger 200 includes five sections: a menu bar 201, a shot window and video player 202, a shot keyword section 203, a keyworder 260, and a bin manager 300. These sections of the logger 200 are described in further detail below, with reference to magnified views shown in FIGS. 9-20B.

FIG. 9 shows an enlarged screen shot of the menu bar 201, according to an embodiment of the present disclosure. The menu bar 201 includes a plurality of user-selectable tabs, which may be configured with drop-down menus for display in response to a user pointing to, mousing over, or selecting a tab of the menu bar 201. In the example shown in FIG. 9, the menu bar 201 includes an active project tab 204, a user tab 205, a project tab 208, a keyword set tab 210, a tool tab 214; a snapshot tab 217, a bookmark tab 221, and a language tab 222.

The active project tab 204 of the menu bar 201 displays information about a currently active project such as, for example, a production number, user name of the user who is currently signed in to use the logger 200, and number of shots in the active project.

The user tab 205 of the menu bar 201 displays the name of the current user and displays a drop-down menu 206 that allows a user to sign into and out of the logger 200, and displays a timestamp 207 showing the last time the user was signed in.

The project tab 208 of the menu bar 201 displays a project menu 209 with options to access various projects and files. The project tab 208 indicates in parentheses the number of projects that are accessible to the current user displayed on the user tab 205.

The keyword set tab 210 of the menu bar 201 displays a keyword set drop-down menu 211 that allows the user to select an existing keyword set to manage from among two lists—an individual keyword set list 212 and a global keyword set list 213. Individual keyword sets are accessible to the user who created the set, whereas global keyword sets are accessible to every user. A number in parentheses next to the individual keyword set list 212 indicates the number of individual keyword sets accessible to the current user displayed on the user tab 205.

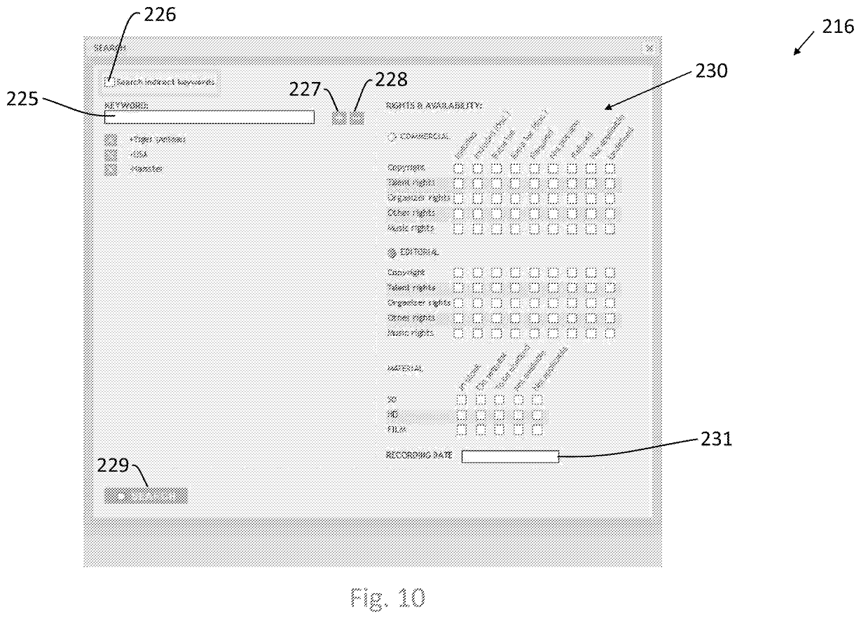

The tool tab 214 of the menu bar 201 displays a tool drop-down menu 215 of tools that allow the user to execute various organizational tasks such as searching for shots, deleting shots, assigning user responsibilities, and the like. A search tool 216 on the tool drop-down menu 215 is described in more detail below with reference to FIG. 10.

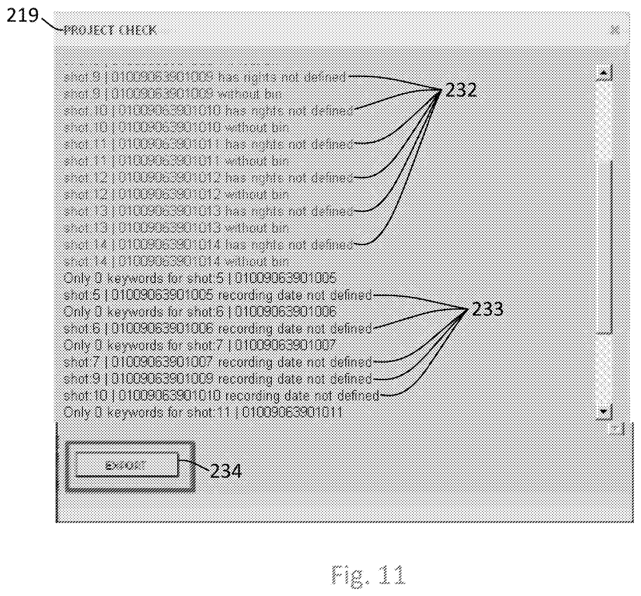

The snapshot tab 217 of the menu bar 201 displays a snapshot drop-down menu 218 that allows the user to save and manage a snapshot of the status of the current project. A project check 219 on the snapshot drop-down menu 218 is described in more detail below with reference to FIG. 11.

The bookmark tab 221 of the menu bar 201, when selected, displays a bookmark drop-down menu 223 that allows the user to access and manage a list of Uniform Resource Locator (URL) links to various Internet web sites for easy reference, e.g., dictionaries and encyclopedias.

The language tab 222 of the menu bar 201 displays a language drop-down menu 223 that allows the user to select a keywording language from among a list of flag icons representing languages supported within the ontological network. The selected language icon 224 is duplicated at the top of the language drop-down menu 223. In the example shown, the selected language is German, and the German keywords will be translated into English, French, Spanish, Italian, and Japanese. The selected keywording language is used to select keywords from, and add keywords to, the taxonomy. When an existing keyword is selected by the user, it is automatically linked to foreign language translations in each of the languages represented by the icons on the language drop-down menu 223. When a new keyword is introduced by the user, the new keyword is automatically translated into all of the languages on the language drop-down menu 223.

FIG. 10 shows a screen shot of the search tool 216, according to an embodiment of the present disclosure. The search tool 216, selectable from the tool drop-down menu 215, permits the user to locate shots in the active project that are associated with certain keywords or rights information. The search tool 216 includes a keyword field 225, a “search indirect keywords” checkbox 226, a “+” button 227, a “−” button 228, a search button 229, a rights matrix 230, and a recording date field 231. To perform a search, the user enters a keyword in the keyword field 225 and uses the “+” button 227 to locate shots containing the keyword, or the “−” button 228 to locate shots that do not contain the keyword. In response, relevant shots will be displayed or highlighted in the shot window and video player 222. Searched keywords are displayed underneath the keyword field 225 and can be deleted from the list by selecting the “x” next to the keyword. By default, the search tool 216 activates a search for shots that contain the keyword as the most specific term, that is, the lowest word keyword in the hierarchy. If the user desires to locate shots associated with the keyword as a broader term, the user can check the “search indirect keywords” checkbox 226. Additionally or alternatively, the user may search for shots within the active project that have certain rights, by selecting a set of rights criteria in the rights matrix 230, or by entering a certain recording date into the recording date field 231. These criteria may also be combined with the keyword search term.

FIG. 11 shows a screen shot of the project check 219, according to an embodiment of the present disclosure. The project check 219 may be activated from the snapshot drop-down menu 218. The project check 219 checks for completeness of metadata logged into the electronic database 84. For example, the project check 219 may assess and report on the completeness of rights, keywords, and bins that have been logged using the logger 200 and associated with the video asset 102. Completeness may be determined by performing a “who-when-where-what-why” check. For example, if no keywords from the main node “Geography” are found, the user may be informed that no location has been specified. The user may then choose to expand the keyword set or confirm the set as it is. Following execution of a project check 219, a list of error messages 232 or warnings 233 may indicate which shots of the video asset 102 are missing information based on which fields of the keyworder 260 or bin manager 300 are empty or marked as “undefined”. Error messages 232 or warnings 233 may be generated, for example, when no rights have been set for a shot, when a shot is assigned to more than one bin, when a shot is not assigned to any bin, when a shot has too few keywords, or when a deleted shot is still assigned to a bin. In some implementations, error messages 232 are distinguished from warnings 233 in the project check results and the error messages 232 must be addressed prior to submission. Once the errors are resolved, the project may be submitted to the electronic database 84 using the “Export project” option of the snapshot drop-down menu 218, or by selecting an export button 234 in the project check window. The presence of errors 232 may cause the export button 234 to be disabled, preventing an attempt to export the project.

FIGS. 12A-12B show screen shots of the shot window and video player 202, according to an embodiment of the present disclosure. The shot window and video player 202 includes a video tab 235 that activates the video player 202a as shown in FIG. 12A, and a zoom tab 236 that activates the shot window 202b, as shown in FIG. 12B. The video player 202a includes a video display window 237, a play/stop button 239, and a slider bar 240. When the video tab 235 is selected, a video having a shot ID number 240 is displayed in the video display window 237. The video player can be started and stopped in the usual way using the play/stop button 239, and the user can move advance or rewind to different frames of the video by moving the slider bar 240 in the usual way. When the MK-zoom tab 236 is selected, a still image corresponding to a shot ID number 240 is displayed in the shot window 202b. The still image may be a representative master key frame. The shot ID number 240 is a multi-digit number that identifies each shot as well as the video as a whole. Shots may be numbered consecutively.

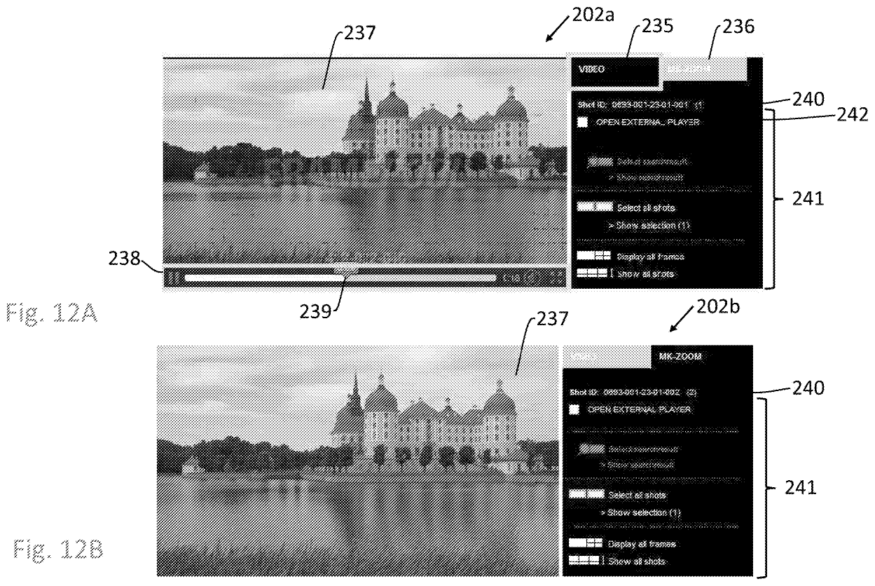

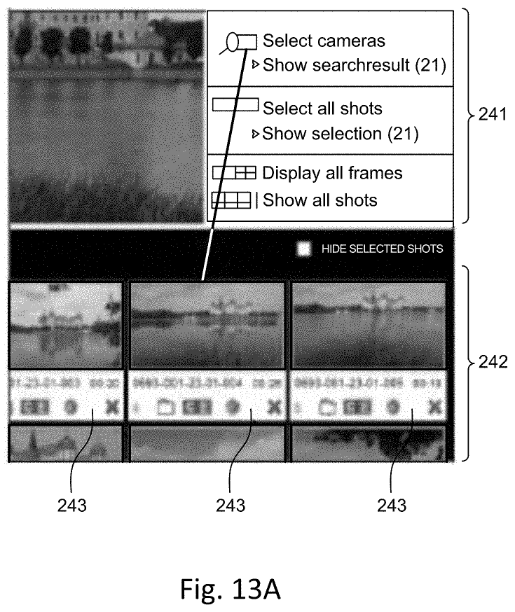

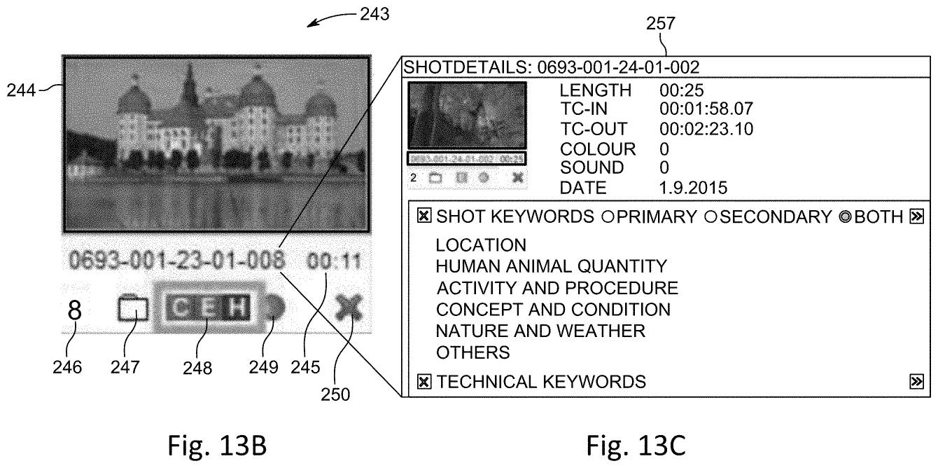

In some implementations, the shot window and video player 202 may include further display options 241 for displaying search results 242 obtained using the search tool 216. FIG. 13A shows search results 242 underneath the video display window 237, displayed as shot icons 244.

FIG. 13B shows an enlarged view of a shot icon 243, according to an embodiment of the present disclosure. The shot icon 243 includes, in addition to a representative image 244, information specific to the shot such as, for example, the shot ID 240, a shot length 245, a shot number 246, a bin indicator 247, a shot category 248, a rights button 249, and a shot delete button 250. The shot length 245 is the length of the shot in minutes and seconds. The bin indicator 247 indicates whether or not the shot is assigned to a bin. The shot category 248 indicates which of various categories the shot has been assigned to, based on its subject matter, e.g., “Creative,” “Editorial,” or “History.” Each shot may be assigned to one, two, or three categories. The color of the rights button 249—green, yellow, or red—indicates what rights information has been applied to the shot. The rights button may be bi-colored. In some implementations, selecting the shot ID 240 within the shot icon 23 opens a “shot details” window 251 as shown in FIG. 13C. The shot details window 251 displays technical information about the shot such as, for example, the length of the shot, whether or not there is an audio track associated with the shot, the date when the shot was recorded, as well as a menu of keyword categories associated with the shot.

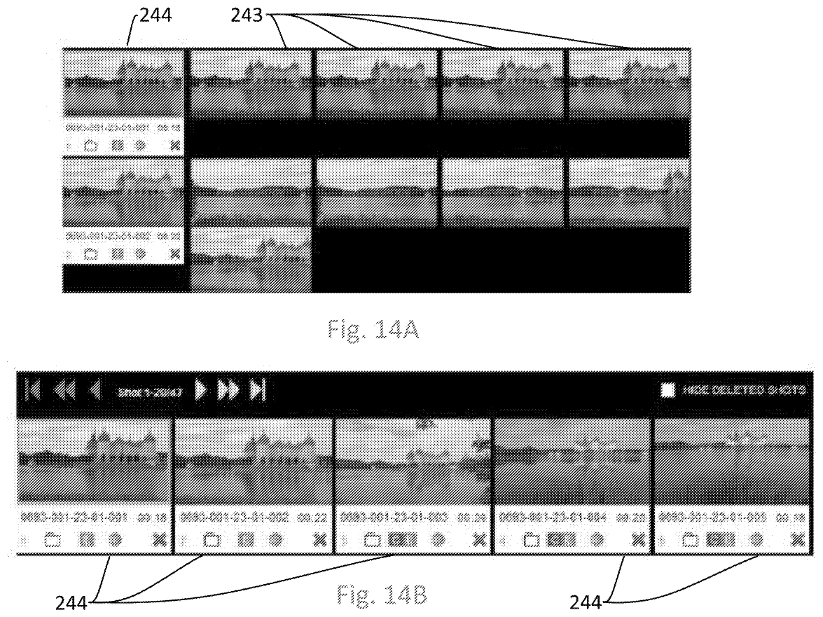

The display options 241 may be configured to permit the user to display all of a shot, portions of shots, all shots in a production, and, when there is a large number of search results, to scroll through pages of shots. Display options 241 may include an “open external player” feature 242 that opens a separate pop-up video display window 237 for each selected shot. Display options 241 may provide for displaying all frames 243 of a shot, as shown in FIG. 14A, or only a representative main frame for each shot, displayed as shot icons 244, as shown in FIG. 14B. In some implementations, selecting a shot icon 244 will activate the shot, which opens the video player 202a if it is not already open, and displays shot keywords, as shown in FIG. 15A.

FIG. 15A shows an enlarged view of the shot keyword section 203a, of the manual logger 200, according to an embodiment of the present disclosure. The shot keyword section 203a shown in FIG. 15A is associated with exemplary shots of a castle as described above with reference to FIGS. 12A-12B, 13A-13B, and 14A-14B. Keywords describing video shots are organized into keyword categories 252 as follows: Primary/Secondary; and Location, Human Animal Quantity, Activity and Procedure, Concept and Condition, Nature and Weather, Others, and Technical Keywords. Primary refers to the main subject of the shot e.g., “lake” or “castle,” while secondary refers to other, less relevant, features in the shot such as background scenery, e.g., “clouds.” Primary/Secondary categorization may be combined with object keywording as discussed above with reference to FIG. 7. In other implementations, different numbers of keyword categories 252 and different keyword category types may be appropriate for archiving keywords associated with other, e.g., non-visual digital media.

FIG. 15A also shows information in the form of a caption 253, a language 254, and a Tec Log description 255. The caption 253 describes the content of the shot(s) while the Tec Log description 255 may originate from a log of the recording session. The same language 254 must apply to both the keywords and the caption 253. Pencil icons 256 permit a user to edit the caption 253 and the Tec Log description 255.

FIG. 15B shows another example of a shot keyword section 203b associated with an image of a young girl throwing a yellow ball (not shown). In some implementations, a caption 253 may be generated automatically from keyword category information, contained in the shot keyword section 203b. An AI program may construct a sentence using, as a subject, the primary keyword “girl” and the adjective “young” from the Human Animal Quantity field. The verb of the sentence is found in the Activity and Procedure field. The object of the sentence is found in the Other field. From these components, a caption may be formed automatically as “A young girl throws a yellow ball.”

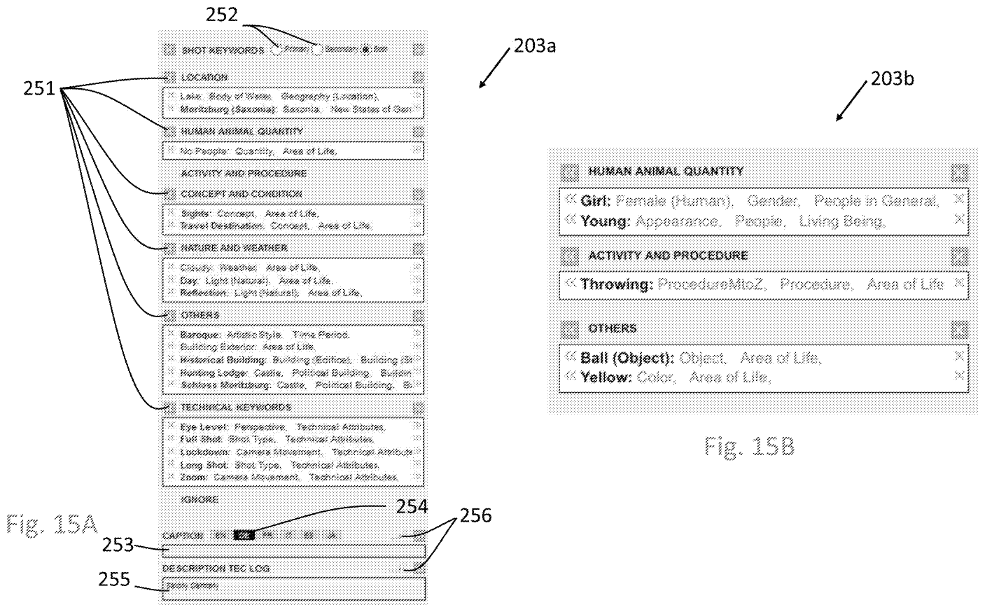

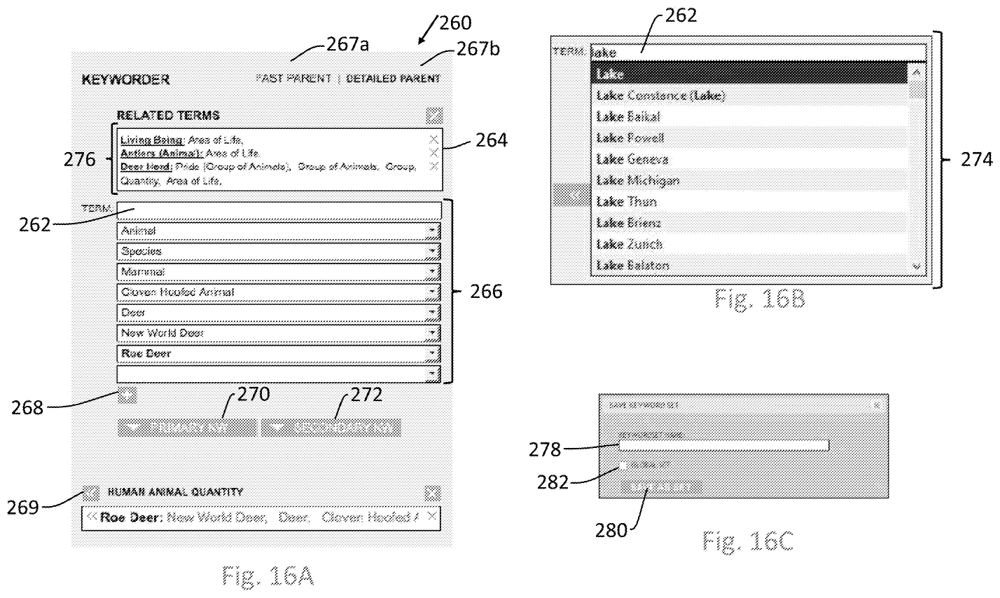

FIGS. 16A-16C show screen shots of the keyworder 260, according to an embodiment of the present disclosure. The keyworder 260 is generated by a logging program that may be executed by the microprocessor 81, and is displayed on the user interface 83 to the digital content classification system 80. The keyworder 260 is a tool for assembling a selection of keywords 104 pertaining to an item of digital media content. The keyworder 260 may be displayed in response to a user requesting to archive metadata for a video asset 102.

In the example shown in FIG. 16A the digital media content is a shot 102a of the deer 163. The keyworder 260 includes an input box 262, a related terms box 264, a keyword list 266, view selectors 267a and 267b, an add button 268, an arrow button 269, a primary keyword designator 270, and a secondary keyword designator 272. A separate keyworder 260 exists for each keyword category. The keyworder 260 shown in FIG. 16A is for the “Human Animal Quantity” category. The arrow button 269 can be used to switch between the keyworders for different keyword categories.

A user may search for a keyword within the existing taxonomy by entering a search term in the “term” input box 262. An example of a search is shown in FIG. 16B, where the user has entered the search term “Lake” in input box 262. In response, the keyworder 260 displays a keyword drop-down menu 274 of all of the lakes that currently exist in the taxonomy, as shown in FIG. 16B. The keyword drop-down menu 274 presented to the user may be arranged, for example, in alphabetical order or according to frequency of use. The user can then select a lake from the list. Following each keyword selection, the user can designate the keyword as primary by selecting the primary keyword designator 270 or as secondary by selecting the secondary keyword designator 272. If the lake that the user is searching for is not in the taxonomy, the user may introduce a new lake keyword to the taxonomy by creating a freeword using the add button 268, and linking the new lake to the parent term “Lake.”

Returning to FIG. 16A, keywords associated with the image of the deer 163 are shown in the keyword list 266. The keyword list 266 is ordered according to the hierarchical data structure 120, with the most general keyword, “Animal” at the top of the keyword list 266, and the most specific term “New World Deer” at the bottom of the keyword list 266. If a user adds the term “Roe Deer’ to the keyword list 266, the parent keywords “New World Deer,” “Deer,” Cloven Hoofed Animal,” and so on, are automatically mapped to the child keyword “Roe Deer.” Subsequently, when a user searches for any of the terms in the keyword list 266, the search results will include at least all of the keywords in the keyword list 266. The keyword list can be displayed in different views. For example, a fast parent view 267a only displays the parent and grandparents of a search term in the input box 262, that is, items above the search term in the hierarchy. Using the detailed parent view 267b, children of the search term in the input box 262 can also be explored.

The order of the keyword list 266 is preserved in the archive so that the search results will return the keyword list 266 as a hierarchy listing the most general keyword at the top of the keyword list 266 to most specific keyword at the bottom keyword list 266. The order of the keyword list 266 may be input by a user. Alternatively, the order of the keyword list 266 may be determined automatically using a numerical score for each keyword. Numerical scores may be supplied by an external source, for example, a search engine or other Internet-based source. Furthermore, the numerical scores may be updated dynamically, based on search engine optimization (SEO) information received from an Internet search engine such as, for example, Google™, Yahoo™ Bing™ YouTube™ and the like. The SEO information may relate to the digital media content, or to the metadata. In some implementations, Numerical scores may be supplied to a user to assist the user in choosing the most relevant keywords to add to the taxonomy, or to enter when searching the archive.

In addition to the keyword drop-down menu 274, the keyworder 260 may display a list of related terms 276 in the related terms box 264. These related terms are offered to the user as proposals for new keywords. The user may then select any number of related terms from the list 276 to be added to the keyword list 266.

Adding and deleting keywords from the taxonomy may be restricted to a designated user such as a taxonomy administrator. The taxonomy administrator may have special authority to expand the set of prescribed keywords included in the network by adding one or more nodes to the network and to contract the set of prescribed keywords included in the network by deleting one or more nodes from the network. The taxonomy administrator may be provided with special access to the electronic database. In some implementations, the taxonomy administrator role may be executed by a machine that is programmed to accept or reject proposed new keywords entered by a user, according to a predetermined set of criteria. Alternatively, such a machine may be programmed to accept or reject proposed new keywords, synonyms, or foreign language translations based on a dynamic set of criteria supplied by an external source, such as an Internet-based search engine. In some implementations, an automated taxonomy administrator may be programmed to manage the keyword network using blockchain techniques.

Once the keyword list 266 is assembled, the user may save the keyword list 266 as a keyword set 278 using the “Save as set” button 280 shown in FIG. 16C. The user can also assign a name to the keyword set, and may designate the keyword set as “global” using a global set checkbox 282, thereby allowing other users to access the keyword set 278. Saving the keyword list causes each of the keywords to be linked, or mapped, to the shot 102a, as well as synonyms for each keyword, and foreign language translations of each keyword. These links are made in the electronic database 84 automatically, without further user input.

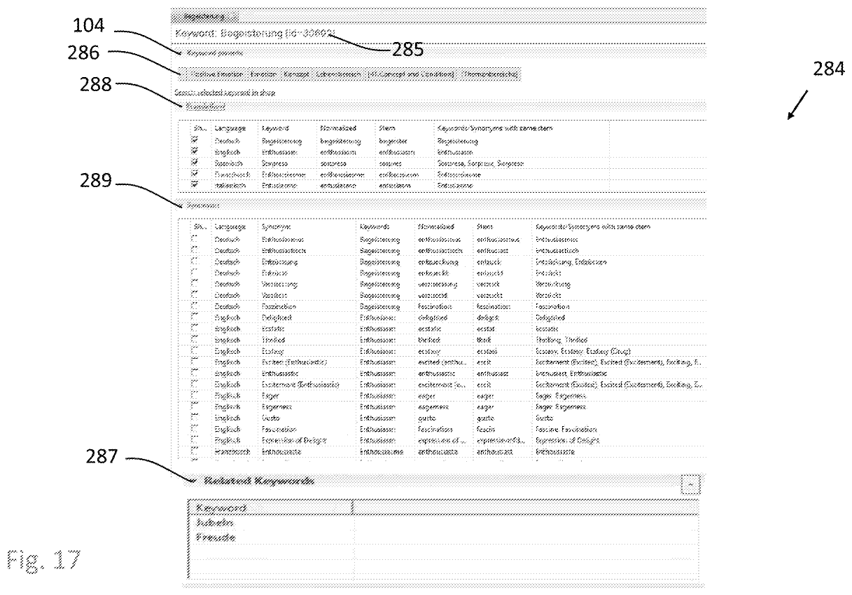

FIG. 17 is a screenshot of keyword mappings 284, according to an embodiment of the present disclosure. The keyword mappings 284 form a networked dataset that may be displayed graphically in the form of a hierarchical data tree as described above. FIG. 17 depicts a way in which a multi-dimensional networked dataset can be implemented on a computer and archived in the electronic database 84. The exemplary keyword “Begeisterung” is a German word meaning “enthusiasm” In English. Each keyword 104 has a unique ID number, 285. The keyword 104 is mapped to its keyword parents and to the keyword category “Concept and Condition” at 286; the keyword 104 is automatically mapped to related terms at 287 the keyword 104 is automatically mapped to multiple foreign language translations at 288; and the keyword 104 is automatically mapped to synonyms at 289. Such automatic population of the interconnected keyword network is one of the most powerful features of the systems and methods described herein.

In addition to mappings, each keyword in a keyword set may have associated links to further information, e.g., Internet-based information. Such links may be accessible by selecting an icon next to the keyword, the icon representing an information service e.g., Google Maps™, Wikipedia™, or Google Images™.

The mapping to keyword parents preserves an ordering so as to be able to display a keyword list 266 as a hierarchy, as described with reference to FIG. 16A. The keyword mapping to synonyms at 289 may be accomplished automatically by programming the microprocessor 81 to recognize and link synonyms within the keyword taxonomy. A large keyword taxonomy that is interconnected as shown in FIG. 17 may be suitable for use as a training database for machine learning and artificial intelligence applications.

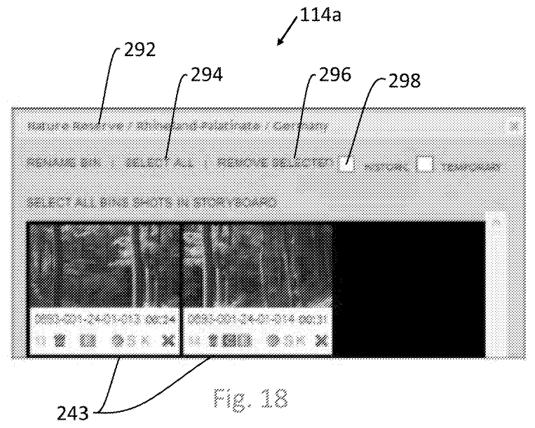

FIG. 18 depicts an example of a bin 114a, according to an embodiment of the present disclosure. In general, bins 114 for video content are used to group together similar shots such as videos or video clips of a common scene, typically recorded at the same time, during the same recording session. Bins 114 are used to organize the digital media content itself, as opposed to metadata describing the content. In the particular implementation as described herein, all shots must be assigned to a bin 114, and bins 114 may contain a maximum of 32 shots.

The exemplary bin 114a includes one or more shots represented by shot icons 243, and a bin name 292. According to a naming convention of the present disclosure, the bin name 292 consists of a string of three keywords common to the shots contained in the bin 114a. Shots can be added to the bin 114a or removed from the bin 114a using a drag-and-drop feature. The “Select All” button 294 can be used to drag and drop all of the shots in the bin 114a at once. The “Remove Selected” button 296 can be used to delete a selected group of shots from the bin 114a. Checking the “historic” box 288 automatically adds the recording date to the bin name 292.

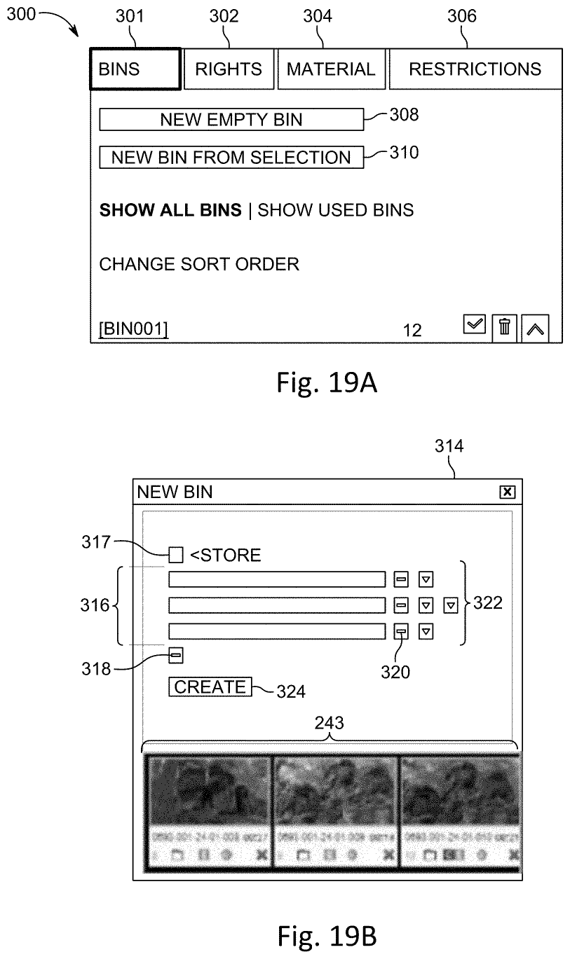

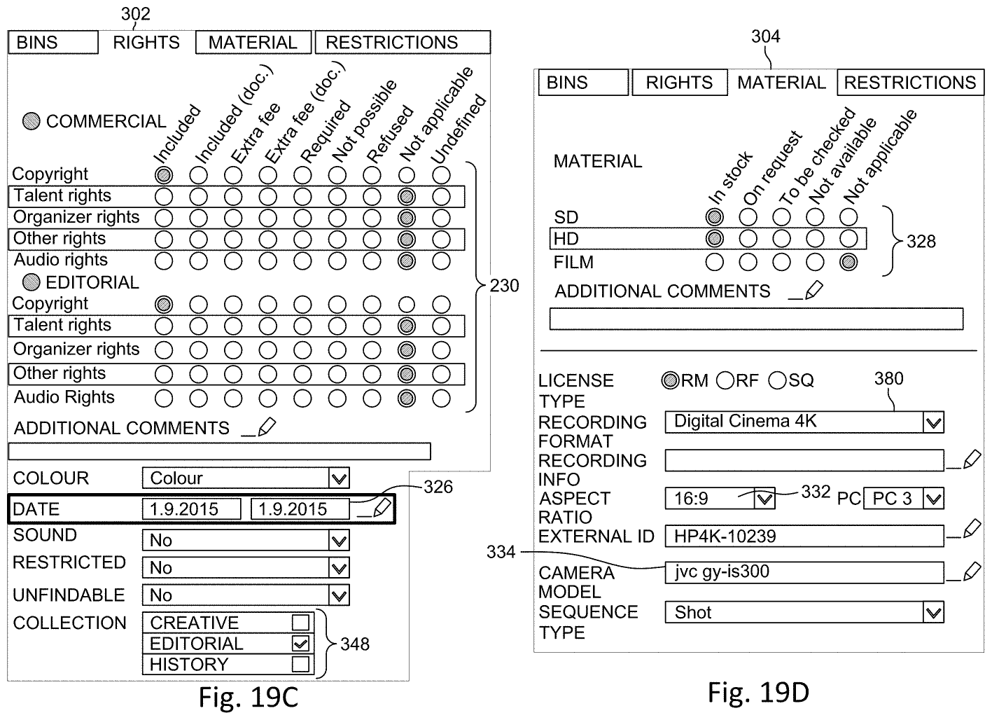

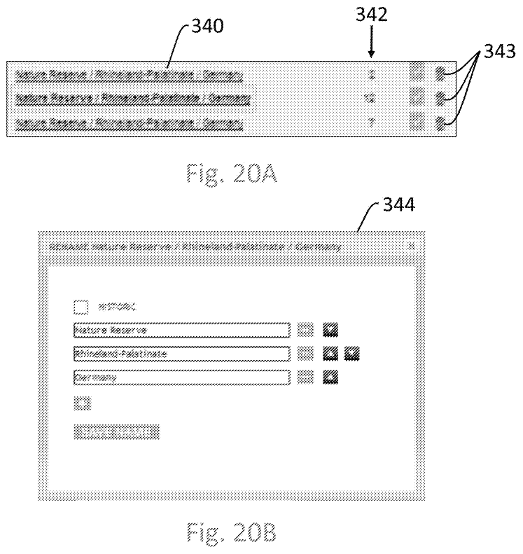

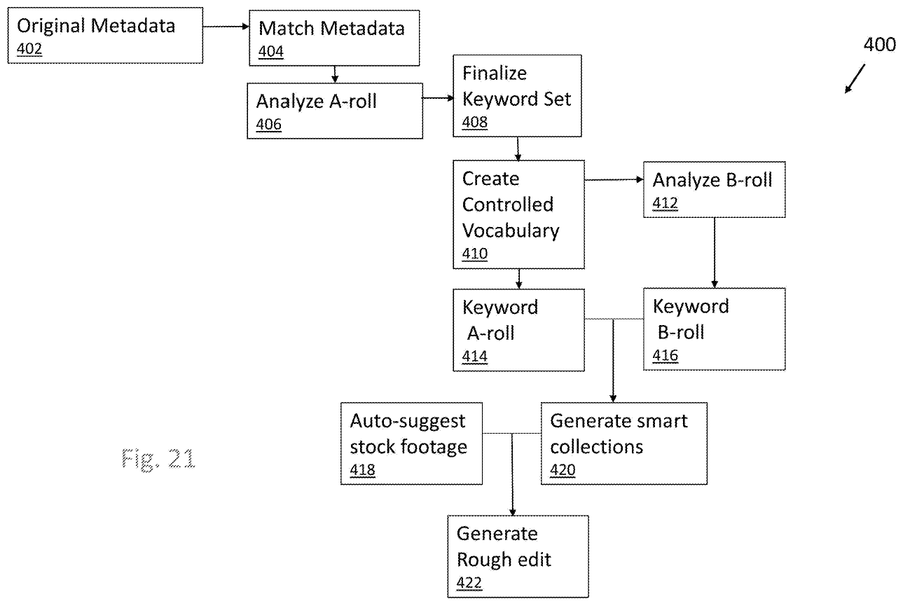

FIGS. 19A-19D and 20A-20B show screen shots of the bin manager user interface 300, according to an embodiment of the present disclosure. The bin manager user interface 300 is a tool for creating and organizing bins 114. The bin manager user interface includes a new bin tab 301, a rights tab 302, a material tab 304, and a restrictions tab 306. Tabs 301, 302, 304, and 306 are described in detail below, with reference to FIGS. 19A-19D

FIG. 19A shows a screen shot of a “new bin” tab 301 that can be used to input and view bins 114. The “new bin” tab 301 includes a “New Empty Bin” button 308, a “New Bin from Selection” button 310, a “Show all Bins” button 312, and a “Show Used Bins” button 314. The “New Empty Bin” button 308 and the “New Bin from Selection” button 310 can be used to create and name a new bin. Selecting the “New Bin from Selection” button 310 displays a new bin user interface 314 as shown in FIG. 19B. The new bin user interface includes three text input boxes 316 for entering three keywords that will make up the bin name 282. Further text input boxes can be added using the “+” button 318, and text input boxes 316 can be removed using the “−” buttons 320. Arrow buttons 322 permit the user to change the order of keywords in the bin name 282. The “Create” button 324 generates the bin containing the shots represented by the shot icons 243 (three shown). Selecting the “New Empty Bin” button 310 displays a new bin user interface 314 as shown in FIG. 19B, but without any shot icons 243 because the bin is empty.

FIG. 19C shows a screen shot of a rights user interface that is displayed in response to a user selecting the rights tab 302. The rights user interface displays the rights matrix 230 that can be used to record various legal rights information associated with shots in the bin. The rights matrix 230 permits a user to record, for example, which commercial rights and editorial rights, e.g., copyrights, are transferred or transferable for a fee, when the shots contained in the bin are licensed or purchased. The rights user interface also displays recording information 326 associated with shots in the bin, such as the recording date. Finally, a user may select one or more shot categories 248 describing the shots in the bin, from among choices such as “creative”, “editorial”, and “history”.

FIG. 19D shows a screen shot of a material user interface that is displayed in response to a user selecting the material tab 304. The material user interface displays a menu that can be used to record technical attributes associated with shots in the bin. The menu may allow a user to select, for example, the resolution of the image at 328, the recording format at 330, the aspect ratio of the image at 332, the camera used to capture the image at 334, and other information.

FIG. 20A shows a bin list 340 listing bins under the name “Nature Reserve/Rhineland-Palatinate/Germany” along with the number of shots 342 in each bin. Multiple bins can be classified under the same name. For example, the first bin in the list includes 2 shots; the second bin has 12 shots and the third bin has 7 shots. In this example, the name includes a geographic location where the shots in the bin were recorded. That is, multiple shots of the deer in the meadow are grouped into a bin that includes the names “Nature Reserve”, “Rhineland-Palatinate” and “Germany”. Wastebasket icons 343 can be used to delete bins.

FIG. 20B shows a screen shot of a re-naming user interface 344 that can be used to re-name an existing bin. Selecting a name from bin list 340 displays the re-naming user interface 344. The re-naming user interface 344 allows a user to edit the three components of the existing bin name, substituting other selections from the keyword taxonomy. Buttons on the re-naming user interface 344 function similar to those in the new bin user interface 314. Once the new names are selected, the “Save Name” button 344 can be used to re-name the bin.

FIG. 21 shows an exemplary method 400 of automating a film editing process, according to an embodiment of the present disclosure. The method 400 combines the keyword taxonomy as described above with artificial intelligence (AI) techniques to automatically assemble a rough edit of a documentary film. In documentary film making and video production, the term “a-roll” refers to footage of interviews, and the term “b-roll” refers to background, or supplemental footage inserted between interviews. B-roll footage may include a separate voice-over or music in place of an audio track. A conventional method of editing a documentary film entails a person viewing and organizing the entire video footage, highlighting the best shots, and matching the b-roll footage to voice-over text, and also to content within the a-roll footage. Such a process can be very time intensive and cumbersome. For larger projects, typos, inconsistencies and inaccurate metadata can create a significant bottleneck.

Alternatively, the method 400 can be implemented using AI in conjunction with a taxonomy builder program to automatically self-assemble a rough edit as follows:

At 402, an original set of metadata is created by keywording scripts or shot lists, or by keywording using a dailies application such as, for example, Copra™ or Arri Webgate™, running on a mobile device. Keywording of the original metadata can be done on the set where the video is recorded. Alternatively, the AI program can be used to automatically recognize and extract keywords from scripts or shot lists.

At 404, the AI program is used to match the original set of metadata with keywords from an existing keyword taxonomy such as the one described above with reference to FIGS. 2-17. The keyword taxonomy provides a condensed and consistent vocabulary so that metadata can be managed and used by the whole production team. The interconnected network of keywords allows team members to locate appropriate content quickly and easily.

At 406, an event detection model, e.g., from MIT/Valossa, and/or transcription software such as SpeedScriber™ is used to analyze and/or transcribe a-roll footage. AI keyword detection is based on original metadata or semi-automated transcription of dialogue, voice over, or other spoken text in the a-roll footage. The AI program can then auto-suggest a set of appropriate keywords from the spoken text of interviews in the a-roll footage.

At 408, the director, editor, or other members of the production team may access the taxonomy directly via a reduced web site to review, update, and approve or reject the keyword set. The keyword set is finalized in this way.

At 410, a controlled vocabulary is created from the selected keyword set and can be loaded into FinalCutPro™. Using a standardized set of keyword metadata for the entire production improves efficiency of the editing process.

At 412, the event detection model, e.g., MIT/Valossa, uses AI to analyze b-roll footage to detect concepts that are within the controlled vocabulary. Results are sent as keyword ranges to FinalCutPro™

At 414 and 416, final range-based keywording is done for the a-roll and b-roll footage using the controlled vocabulary, and favorites are set to highlight the best ranges.

At 418, the AI program detects missing content and auto-suggests stock footage to fill the gaps if no matching b-roll can be found.

At 420, FinalCutPro™ and Applescript™ are used to generate smart collections based on keywords used and favorites.

At 422, FinalCutPro™ and Applescript™ are used to automatically generate a rough edit based on the smart collections and favorites, by appending the favorite ranges inside the smart collections that contain the matching ranges of the a-roll and b-roll.

In some implementations, automatic detection of objects within a video asset may be refined by accessing external database information. For example, if an AI object detection model identifies an animal object in a video asset 102 as being an elephant, and the location of the video is also known, then metadata associated with the video asset 102 and/or the elephant object can be matched with external information from a knowledge database to narrow down the species of elephant, and thus to enhance the machine learning results. Such external information may be obtained from Internet-based sources such as, for example, Wikidata.

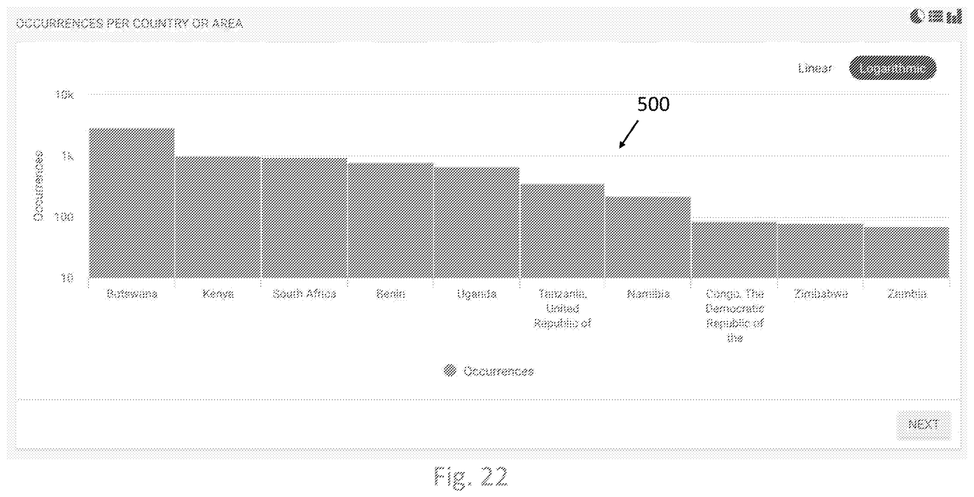

FIG. 22 shows a first exemplary chart 500 displaying the number of occurrences per country of the African elephant species “Loxodonta Africana” obtained from an Internet web site https://www.gbif.org/species/8781257/metrics.

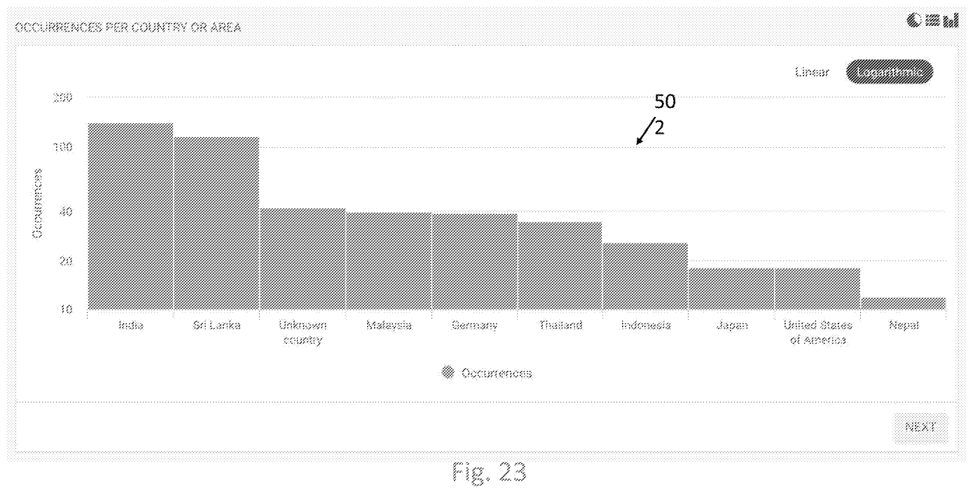

FIG. 23 shows a second exemplary chart 502 displaying the number of occurrences per country of the Indian elephant species “Elephas Maximus Linnaeus” obtained from an Internet web site https://www.gbif.org/species/5219461/metrics. By combining external information in FIGS. 22, 23 with the known metadata attached to the elephant object or the video asset as a whole, the species of elephant can be narrowed down, with high probability, to an African elephant species or an Indian elephant species.

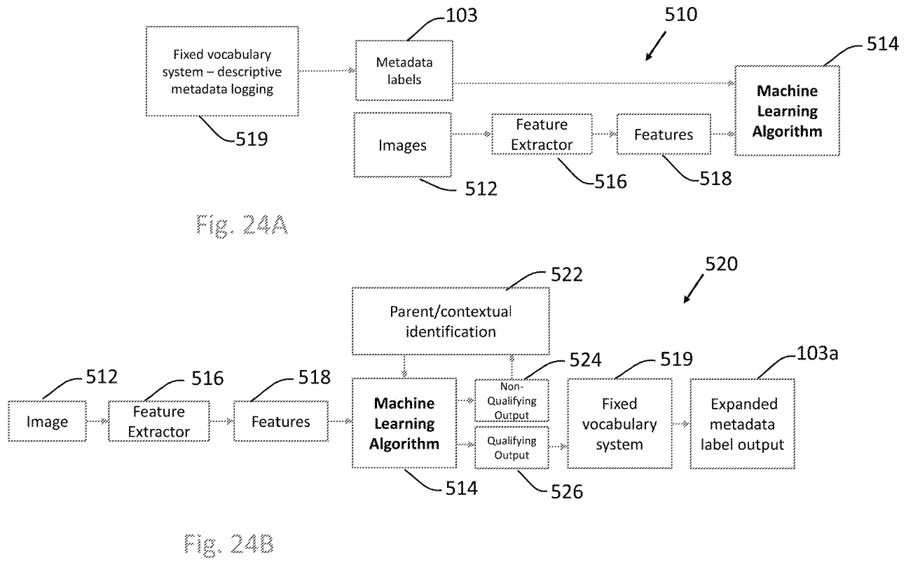

FIGS. 24A and 24B illustrate two phases of an AI machine learning procedure, according to an embodiment of the present disclosure. In a training phase 510 shown in FIG. 24A, images 512, and metadata 103 are sources of inputs to a machine learning algorithm 514. The images 512 may be still images or individual frames 102a of a video asset 102. A feature extractor 516 extracts features 518 from the images 512 and provides the features 518 as inputs to the machine learning algorithm 514. The feature extractor may include, for example, the computer vision device 85, associated code, or portions thereof. With reference to FIG. 5, the features 518 may include, for example, objects 163, 164 of the frame 102a. Metadata 103 for input into the machine learning algorithm 514 is provided by a fixed vocabulary system 519, e.g., the hierarchical taxonomy that is archived within the digital media classification system 80 as described above.

In a prediction phase 520 shown in FIG. 24B, parent and contextual information 522 provides additional inputs from the ontological network described herein to the machine learning algorithm 514. The parent and contextual information 522 can trigger alternative machine learning algorithms 514 to identify parent or other models for related terms and foreign language translations to improve performance. Outputs from the machine learning algorithm 514 are then tested to determine whether or not they meet performance requirements. Non-qualifying output 524 is returned to the fixed vocabulary system 519 for further contextual identification using the interconnected ontological network. Qualifying output 526 from the machine learning algorithm 514 is fed back into the fixed vocabulary system 519 to create expanded metadata 103a using the ontological network of keywords 104, e.g., keyword parents at 286, synonyms at 289, and associated foreign language translations at 288.

The various embodiments described above can be combined to provide further embodiments. These and other changes can be made to the embodiments in light of the above-detailed description. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described exemplary embodiments, but should be defined only in accordance with the following claims and their equivalents.

A

1

-A

15

. (canceled)

B1-B27. (canceled)

C1. (canceled)

D1-D10. (canceled)

E1. (canceled)

F1. (canceled)

G1-G14. (canceled)

H1-H2. (canceled)

73. An apparatus for interfacing to a digital content classification system, the apparatus comprising:
an electronic memory;
a microprocessor, programmable with a set of instructions to store information in the electronic memory and that, when executed by the microprocessor, cause the microprocessor to:
detect a first input comprising a digital media content for storage in the electronic memory;
present, via a data input device, metadata choices comprising a set of prescribed descriptors stored in the electronic memory, the set of prescribed descriptors identifying the digital media content;
detect a second input comprising a selection of metadata from among the metadata choices; and,
associate, within the electronic memory, the selection of metadata with the digital media content; and,
wherein the information in the electronic memory further comprises, as nodes in the digital content classification system, a set of keywords linked to the metadata by at least one of a synonym, a homonym, or a foreign language translation, and,
wherein a search for any one of the set of keywords retrieves the digital media content from the electronic memory.

74. The apparatus according to claim 73, wherein the first input and the second input are supplied by a computer vision device capable of interpreting a digital image within the digital media content.

75. The apparatus according to claim 74, wherein the computer vision device is programmed to detect, within the digital image, at least one of a primary object, a secondary object, and an activity.

76. The apparatus according to claim 73, wherein a numerical score is associated with at least one keyword in the set of keywords and is thereafter used to automatically determine an ordering of the keyword.

77. The apparatus according to claim 76, wherein the numerical score is supplied to a user of the apparatus during the search for any one of the set of keywords.

78. The apparatus according to claim 73, wherein the digital media content comprises at least one of a digital image, a digital video, a digital text information, and a digital audio track.

79. The apparatus according to claim 73, wherein the digital media content comprises at least one of a video, in which similar videos are sorted into bins, and the set of prescribed descriptors includes bin identification information.

80. The apparatus according to claim 73, wherein at least one keyword in the set of keywords is associated with an object within the digital media content.

81. A method, implemented on a computer, for interfacing to a digital content classification system, comprising the steps of:
storing, in an electronic database, a set of metadata for use in identifying digital media content, the set of metadata including at least one prescribed keyword arranged as an interconnected node in the digital content classification system;
accepting as input the at least one prescribed keyword to describe the digital media content;
storing the digital media content in the electronic database; and, associating the at least one prescribed keyword with the stored digital media content so that a subsequent search for the at least one prescribed keyword retrieves the digital media content from the electronic database.

82. The method according to claim 81, further comprising the step of:
assigning the digital media content to a bin, based on the at least one prescribed keyword.

83. The method according to claim 81, further comprising the step of:
associating a set of related terms from the digital content classification system to the at least one prescribed keyword so that a subsequent search of the electronic database for at least one of the set of associated related terms retrieves the digital media content from the electronic database.

84. The method according to claim 81, further comprising the steps of:
accepting instructions from a taxonomy administrator to expand the at least one prescribed keyword by adding one or more nodes to the digital content classification system; and,
accepting instructions from a taxonomy administrator to reduce the at least one prescribed keyword by deleting one or more nodes from the digital content classification system.

85. The method according to claim 84, wherein the taxonomy administrator is one of a smart machine and a user.

86. A computer-implemented method of generating a dataset suitable for use in testing a machine learning algorithm, the method comprising the steps of:
storing a set of digital information in an electronic database;
inputting a set of metadata in the electronic database;
associating the set of metadata with the set of digital information to create a digital dataset;
ordering the set of metadata; and,
displaying, on an electronic display, the ordered set of metadata in a hierarchical data tree, and,
wherein the set of metadata describing a general category of the digital dataset are displayed at a top-level of the hierarchical data tree and the set of metadata describing a specific category of the digital dataset are displayed at a bottom-level of the hierarchical data tree.

87. The computer-implemented method of claim 86, wherein the set of digital information is a digital media content comprising at least one of a digital image, a digital video, a digital audio track, and a digitized print media.

88. The computer-implemented method of claim 86, wherein the set of digital information comprises at least one digital image and further wherein the at least one digital image is supplied by an electronic computer vision device configured to interpret the at least one digital image.

89. The computer-implemented method of claim 86, wherein the step of ordering the set of metadata is done by a user.

90. The computer-implemented method of claim 86, wherein the step of ordering the set of metadata is done by a smart machine.

91. The computer-implemented method of claim 86, further comprising the step of:
assigning numerical scores within the set of metadata, and
wherein the step of ordering the set of metadata is based on the assigned numerical scores.

92. The computer-implemented method of claim 86, further comprising the step of:
matching the set of metadata and a set of keywords with external information to enhance machine learning.
